(19) United States
(12) Patent Application Publication
(10) Pub. No.: US 2020/0316621 A1
(43) Pub. Date: Oct. 8, 2020

(54) FUEL DISTRIBUTION PIPE

(71) Applicant: Sanoh Industrial Co., Ltd., Shibuya-ku, Tokyo (JP)

(72) Inventor: Nobushi YAMAZAKI, Koga-shi, Ibaraki (JP)

(21) Appl. No.: 16/087,944

(22) PCT Filed: Oct. 31, 2016
(86) PCT No.: PCT/JP2016/082307

§ 371 Date: Sep. 24, 2018

(30) Foreign Application Priority Data
Mar. 25, 2016 (JP) 2016-062258

(51) Int. Cl. B05B 1/20; F02M 55/02

(52) U.S. Cl. CPC B05B 1/20; F02M 55/025

(57) ABSTRACT

There is provided a fuel distribution pipe 10 that distributes and supplies fuel supplied from a fuel pipe 2 to a plurality of fuel injection devices 3. The fuel distribution pipe 10 includes a pipe part 11 that stores the fuel in a high-pressure state, and a plurality of housings 12 that are joined to the pipe part 11 and supply the fuel to the fuel injection devices 3. A first housing 12A from among the plurality of housings 12 includes a first connection opening 17 that is connected to the fuel pipe 2 and communicates with the pipe part 11.

### TECHNICAL FIELD

The present invention relates to a fuel distribution pipe that distributes and supplies fuel to a plurality of fuel injection devices.

### BACKGROUND ART

A fuel distribution pipe is used in a direct injection engine and the like, to distribute and supply high-pressure fuel, which is compressed by a high-pressure pump, to a plurality of fuel injection devices. A fuel distribution pipe disclosed in Patent Literature 1 includes pipe parts (2, 3) that store high-pressure fuel therein. An inlet connector (1) to which a fuel pipe connected to a high-pressure pump is to be connected, a plurality of outlet connectors (3a, 3b) to which a plurality of fuel injection devices are to be connected, and a pressure sensor (8) that detects the pressure of fuel present in the fuel distribution pipe are joined to the pipe part. Further, after the fuel distribution pipe temporarily stores the high-pressure fuel, which is supplied from the fuel pipe, in the pipe parts, the fuel distribution pipe distributes and supplies the fuel to the respective fuel injection devices from the plurality of outlet connectors. Furthermore, since the pressure sensor detects the pressure of fuel present in the pipe part, it is possible to check whether or not the pressure of fuel present in the pipe part is in a predetermined pressure range.

### CITATION LIST

### Patent Literature

Patent Literature 1: Japanese Patent No. 4209399

### SUMMARY OF INVENTION

### Technical Problem

Incidentally, since a reduction in the cost of components to be mounted on a vehicle has been strongly demanded in recent years, a reduction in the cost of the fuel distribution pipe has also been strongly demanded likewise.

However, since the fuel distribution pipe disclosed in Patent Literature 1 has a structure in which components, such as the pipe parts, the inlet connector, the plurality of outlet connectors, and the pressure sensor, are joined, the number of the components of the fuel distribution pipe is large. For this reason, there is a limit to a reduction in material cost, the number of manufacturing steps, and the like.

Accordingly, an object of an aspect of the invention is to provide a fuel distribution pipe of which manufacturing cost can be reduced through a reduction in the number of components.

### Solution to Problem

A fuel distribution pipe according to an aspect of the invention is a fuel distribution pipe that distributes and supplies fuel supplied from a fuel pipe to a plurality of fuel injection devices. The fuel distribution pipe includes a pipe part that stores the fuel in a high-pressure state and a plurality of housings that are joined to the pipe part and supply the fuel to the fuel injection devices. A first housing from among the plurality of housings includes a first connection opening that is connected to the fuel pipe and communicates with the pipe part.

In the fuel distribution pipe according to the aspect of the invention, the first housing from among the plurality of housings includes the first connection opening that is connected to the fuel pipe and communicates with the pipe part. That is, the first housing supplies the fuel to the fuel injection device, and supplies the fuel, which is supplied from the fuel pipe, to the pipe part. For this reason, a component, which is separate from the housing and supplies the fuel supplied from the fuel pipe to the pipe part, is unnecessary. Accordingly, since the number of components is reduced, manufacturing cost can be reduced.

A fuel distribution pipe according to an aspect of the invention is a fuel distribution pipe that distributes and supplies fuel supplied from a fuel pipe to a plurality of fuel injection devices. The fuel distribution pipe includes a pipe part that stores the fuel in a high-pressure state and a plurality of housings that are joined to the pipe part and supply the fuel to the fuel injection devices. A second housing from among the plurality of housings includes a second connection opening that is connected to a fuel pressure sensor detecting the pressure of the fuel and communicates with the pipe part.

In the fuel distribution pipe according to the aspect of the invention, the second housing from among the plurality of housings includes the second connection opening that is connected to the fuel pressure sensor and communicates with the pipe part. That is, the second housing supplies the fuel to the fuel injection device and supplies the fuel, which is stored in the pipe part, to the fuel pressure sensor. For this reason, a component, which is separate from the housing and supplies the fuel stored in the pipe part to the fuel pressure sensor, is unnecessary. Accordingly, since the number of components is reduced, manufacturing cost can be reduced.

A fuel distribution pipe according to an aspect of the invention is a fuel distribution pipe that distributes and supplies fuel supplied from a fuel pipe to a plurality of fuel injection devices. The fuel distribution pipe includes a pipe part that stores the fuel in a high-pressure state and a plurality of housings that are joined to the pipe part and supply the fuel to the fuel injection devices. A first housing from among the plurality of housings includes a first connection opening that is connected to the fuel pipe and communicates with the pipe part, and a second housing from among the plurality of housings includes a second connection opening that is connected to a fuel pressure sensor detecting the pressure of the fuel and communicates with the pipe part.

In the fuel distribution pipe according to the aspect of the invention, the first housing from among the plurality of housings includes the first connection opening that is connected to the fuel pipe and communicates with the pipe part. That is, the first housing supplies the fuel to the fuel injection device, and supplies the fuel, which is supplied from the fuel pipe, to the pipe part. For this reason, a component, which is separate from the housing and supplies the fuel supplied from the fuel pipe to the pipe part, is unnecessary. Further, the second housing from among the plurality of housings includes the second connection opening that is connected to the fuel pressure sensor and communicates with the pipe part. That is, the second housing supplies the fuel to the fuel injection device and supplies the fuel, which is stored in the pipe part, to the fuel pressure sensor. For this reason, a component, which is separate from the housing and supplies the fuel stored in the pipe part to the fuel pressure sensor, is unnecessary. Accordingly, since the number of components is reduced, manufacturing cost can be reduced.

In this case, the first and second housings may be housings that are not adjacent to each other. In the fuel distribution pipe, the second housing, which supplies the fuel to the fuel pressure sensor, is provided at a position away from the first housing that supplies the fuel supplied from the fuel pipe to the pipe part. For this reason, the influence of the pulsation of fuel, which is caused by the operation of a high-pressure pump, on the fuel pressure sensor can be suppressed. Accordingly, a change in the pressure of fuel, which is detected by the fuel pressure sensor, caused by the pulsation of fuel can be suppressed.

A fuel distribution pipe according to an aspect of the invention is a fuel distribution pipe that distributes and supplies fuel supplied from a fuel pipe to a plurality of fuel injection devices. The fuel distribution pipe includes a pipe part that stores the fuel in a high-pressure state and a plurality of housings that are joined to the pipe part and supply the fuel to the fuel injection devices. A third housing from among the plurality of housings includes a first connection opening that is connected to the fuel pipe and communicates with the pipe part, and a second connection opening that is connected to a fuel pressure sensor detecting the pressure of the fuel and communicates with the pipe part.

In the fuel distribution pipe according to the aspect of the invention, the third housing from among the plurality of housings includes the first connection opening that is connected to the fuel pipe and communicates with the pipe part, and the second connection opening that is connected to the fuel pressure sensor and communicates with the pipe part. That is, the third housing supplies the fuel to the fuel injection device, supplies the fuel supplied from the fuel pipe to the pipe part, and supplies the fuel stored in the pipe part to the fuel pressure sensor. For this reason, a component, which is separate from the housing and supplies the fuel supplied from the fuel pipe to the pipe part, and a component, which is separate from the housing and supplies the fuel stored in the pipe part to the fuel pressure sensor, are unnecessary. Accordingly, since the number of components is reduced, manufacturing cost can be reduced.

A fuel distribution pipe according to an aspect of the invention is a fuel distribution pipe that distributes and supplies fuel supplied from a fuel pipe to a plurality of fuel injection devices. The fuel distribution pipe includes: a first fuel distribution pipe unit that includes a pipe part storing the fuel in a high-pressure state and a plurality of housings joined to the pipe part and supplying the fuel to the fuel injection devices, a first housing from among the plurality of housings including a first connection opening that is connected to the fuel pipe and communicates with the pipe part; a second fuel distribution pipe unit that includes a pipe part storing the fuel in a high-pressure state and a plurality of housings joined to the pipe part and supplying the fuel to the fuel injection devices, a second housing from among the plurality of housings including a second connection opening that is connected to a fuel pressure sensor detecting the pressure of the fuel and communicates with the pipe part; and a connection pipe unit that connects the first fuel distribution pipe unit to the second fuel distribution pipe unit and communicates with the pipe part of the first fuel distribution pipe unit and the pipe part of the second fuel distribution pipe unit.

Since the fuel distribution pipe according to the aspect of the invention includes first fuel distribution pipe unit and the second fuel distribution pipe unit, the fuel distribution pipe can be appropriately mounted on a V-engine. Further, since the pipe part of the first fuel distribution pipe unit and the pipe part of the second fuel distribution pipe unit communicate with each other through the connection pipe unit, fuel can be supplied to the second fuel distribution pipe unit through the first fuel distribution pipe unit. Accordingly, a fuel supply route can be simplified. Furthermore, the first fuel distribution pipe unit is provided with the first housing that includes the first connection opening to be connected to the fuel pipe, and the second fuel distribution pipe unit is provided with the second housing that includes the second connection opening to be connected to the fuel pressure sensor. Accordingly, both the pressure of the fuel of the first fuel distribution pipe unit and the pressure of the fuel of the second fuel distribution pipe unit can be detected by one fuel pressure sensor.

In the fuel distribution pipe, each of the housings may include a supply port that supplies the fuel to one of the fuel injection devices, and the fuel distribution pipe may further include first connection flow passages that are each connected to the pipe part and the supply port and a second connection flow passage that is connected to the first connection opening and the pipe part. In the fuel distribution pipe, the fuel supplied from the fuel pipe is supplied to the respective fuel injection devices through the first connection flow passages after being supplied to the pipe part through the second connection flow passage. For this reason, fuel of which the pressure is made uniform can be supplied to the respective fuel injection devices.

In this case, the second connection flow passage may include a reduced-diameter portion of which the diameter is smaller than the diameter of the first connection flow passage. In the fuel distribution pipe, the pressure loss of fuel passing through the second connection flow passage is larger than the pressure loss of fuel passing through the first connection flow passage since the second connection flow passage includes the reduced-diameter portion of which the diameter is smaller than the diameter of the first connection flow passage. Accordingly, since fuel easily flows to the supply ports of the respective housings from the pipe part, the pressure of fuel to be supplied to all the fuel injection devices can be made more uniform.

Meanwhile, in the fuel distribution pipe, each of the housings may include a supply port that supplies the fuel to one of the fuel injection devices, and the fuel distribution pipe may further include first connection flow passages that are each connected to the pipe part and the supply port and a third connection flow passage that is connected to the first connection opening and the supply ports. In the fuel distribution pipe, the fuel supplied from the fuel pipe is supplied to the fuel injection device from the supply port of the first housing through the third connection flow passage. Further, the fuel supplied to the supply port of the first housing is supplied to the respective fuel injection devices from the other housings after being supplied to the pipe part through the first connection flow passage. In regard to this flow of the fuel, fuel is not supplied to the supply port of the first housing from the pipe part or it is difficult for fuel to be supplied to the supply port of the first housing from the pipe part. For this reason, it is difficult for the pulsation of fuel, which is generated due to the injection of fuel from the fuel injection device, to be transmitted to the pipe part in the first housing. Accordingly, since strength, which is required for the pipe part, can be made low, material cost can be reduced through a reduction in the thickness of the wall of the pipe part. Furthermore, since a flow passage to be connected to the first connection opening and the pipe part is not formed, the number of holes to be formed in the pipe part can be made smaller than that in a case in which the flow passage is formed. Accordingly, since strength, which is required for the pipe part, can be made low, material cost can be reduced through a reduction in the thickness of the wall of the pipe part.

In this case, the third connection flow passage may include a reduced-diameter portion of which the diameter is smaller than the diameter of the first connection flow passage. In the fuel distribution pipe, the pressure loss of fuel passing through the third connection flow passage is larger than the pressure loss of fuel passing through the first connection flow passage since the third connection flow passage includes the reduced-diameter portion of which the diameter is smaller than the diameter of the first connection flow passage. Accordingly, since fuel easily flows to the pipe part from the supply port of the first housing, the pressure of fuel to be supplied to all the fuel injection devices can be made more uniform.

### Advantageous Effects of Invention

According to the aspect of the invention, manufacturing cost can be reduced through a reduction in the number of components.

### BRIEF DESCRIPTION OF DRAWINGS

FIG. 1 is a schematic perspective view of a fuel distribution pipe according to a first embodiment.

FIG. 2 is a schematic cross-sectional view of the fuel distribution pipe according to the first embodiment.

FIG. 3 is a schematic cross-sectional view taken along line III-III illustrated in FIG. 2.

FIG. 4 is a schematic cross-sectional view taken along line IV-IV illustrated in FIG. 2.

FIG. 5 is a schematic cross-sectional view of a fuel distribution pipe according to a second embodiment.

FIG. 6 is a schematic perspective view of a fuel distribution pipe according to a third embodiment.

FIG. 7 is a schematic cross-sectional view of the fuel distribution pipe according to the third embodiment.

FIG. 8 is a schematic cross-sectional view taken along line VIII-VIII illustrated in FIG. 7.

FIG. 9 is a schematic cross-sectional view of a fuel distribution pipe according to a fourth embodiment.

FIG. 10 is a schematic perspective view of a fuel distribution pipe according to a fifth embodiment.

FIG. 11 is a schematic cross-sectional view of the fuel distribution pipe according to the fifth embodiment.

FIG. 12 is a schematic cross-sectional view of a fuel distribution pipe according to a sixth embodiment.

FIG. 13 is a schematic perspective view of a fuel distribution pipe according to a seventh embodiment.

### DESCRIPTION OF EMBODIMENTS

Fuel distribution pipes according to embodiments will be described below with reference to drawings. Meanwhile, the same or corresponding elements in the respective drawings will be denoted by the same reference numerals and the repeated description thereof will be omitted.

### First Embodiment

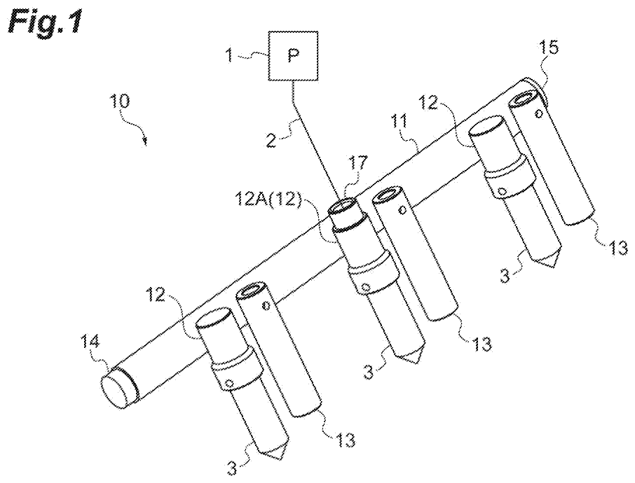

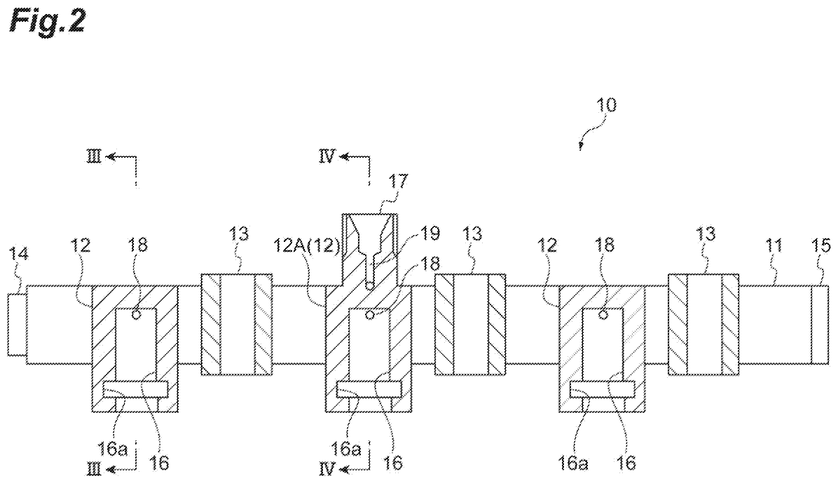

FIG. 1 is a schematic perspective view of a fuel distribution pipe according to a first embodiment. FIG. 2 is a schematic cross-sectional view of the fuel distribution pipe according to the first embodiment. As illustrated in FIGS. 1 and 2, a fuel distribution pipe 10 according to this embodiment is to distribute and supply high-pressure fuel, which is compressed by a high-pressure pump 1 and is supplied from a fuel pipe 2, to fuel injection devices 3 that are provided so as to correspond to the respective cylinders of an engine (not illustrated).

The fuel distribution pipe 10 is also called a fuel injection rail, a fuel delivery pipe, a common rail, and the like.

The fuel distribution pipe 10 includes a pipe part 11, a plurality of housings 12, fixing bosses 13, and a fuel pressure sensor 14. Meanwhile, the fuel distribution pipe 10 including three housings 12 is illustrated in FIG. 1. However, the number of the housings 12 is not particularly limited as long as being two or more.

The pipe part 11 stores fuel, which is pumped from the high-pressure pump 1, in a high-pressure state to supply fuel to the plurality of fuel injection devices 3. The pipe part 11 is formed in the shape of a circular tube that linearly extends along the direction of the row of the cylinders of the engine (the axial direction of a crank). The inside of the pipe part 11 forms a storage space 11a that stores fuel. Meanwhile, the tubular shape of the pipe part 11 does not necessarily need to be the shape of the circular tube linearly extending, and may be various shapes.

A lid part 15 is mounted on one end portion of the pipe part 11, and one end portion of the storage space 11a formed in the pipe part 11 is closed by the lid part 15. The fuel pressure sensor 14 is mounted on the other end portion of the pipe part 11, and the other end portion of the storage space 11a formed in the pipe part 11 is closed by the fuel pressure sensor 14. The mounting of the lid part 15 and the fuel pressure sensor 14 on the pipe part 11 can be achieved by brazing, welding, screwing, or the like.

The housings 12 airtightly hold the fuel injection devices 3, and supply fuel to the fuel injection devices 3. The housings 12 are joined to the pipe part 11. The joining of the housings 12 to the pipe part 11 can be achieved by brazing, welding, screwing, or the like. The housings 12 are provided so as to correspond to the fuel injection devices 3.

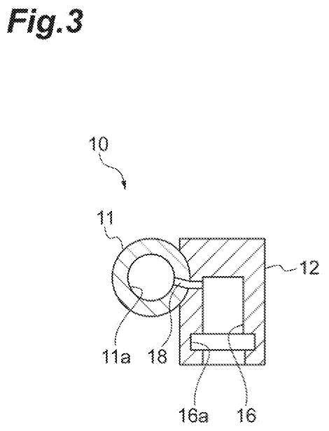

FIG. 3 is a schematic cross-sectional view taken along line III-III illustrated in FIG. 2. As illustrated in FIGS. 2 and 3, each of the housings 12 includes an insertion opening 16 into which the fuel injection device 3 is inserted and which holds the fuel injection device 3.

The insertion opening 16 is a depression (recessed portion) that is formed in each housing 12 and has a circular cross-section. A locking groove 16a, which locks a flange portion (not illustrated) formed on the fuel injection device 3, is formed on the inner peripheral surface of the insertion opening 16. That is, since the flange portion of the fuel injection device 3 inserted into the insertion opening 16 is fitted to the locking groove 16a, the fuel injection device 3 can be held in the housing 12 in a state in which the fuel injection device 3 is inserted into the insertion opening 16. Meanwhile, a holding structure for the fuel injection device 3 in the housing 12 is not particularly limited, and other holding structures may be employed.

Further, the insertion opening 16 communicates with the storage space 11a, which is formed in the pipe part 11, through a first connection flow passage 18. The first connection flow passage 18 is a flow passage through which fuel passes, and is connected to the pipe part 11 and the insertion opening 16. That is, one end of the first connection flow passage 18 is opened to the storage space 11a, and the other end of the first connection flow passage 18 is opened to the insertion opening 16. For this reason, the insertion opening 16 functions as a supply port that supplies fuel to the fuel injection device 3.

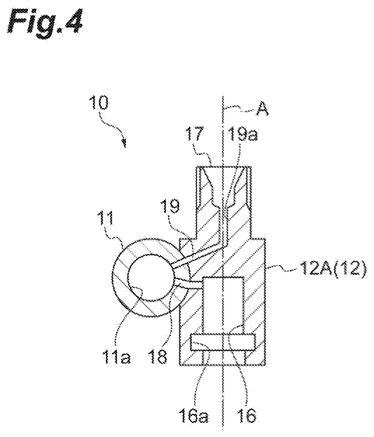

FIG. 4 is a schematic cross-sectional view taken along line IV-IV illustrated in FIG. 2. As illustrated in FIGS. 2 and 4, one of the plurality of housings 12 is a first housing 12A. The first housing 12A further includes a first connection opening 17 in addition to the structure of the other housing 12. Meanwhile, each of the other housings 12 other than the first housing 12A does not include the first connection opening 17.

The first connection opening 17 is connected to the fuel pipe 2, so that fuel is supplied to the first connection opening 17 from the fuel pipe 2. The first connection opening 17 is a depression (recessed portion) that is formed in the first housing 12A and has a circular cross-section. The first connection opening 17 communicates with the storage space 11a, which is formed in the pipe part 11, through a second connection flow passage 19. The second connection flow passage 19 is a flow passage through which fuel passes, and is connected to the first connection opening 17 and the pipe part 11. That is, one end of the second connection flow passage 19 is opened to the first connection opening 17, and the other end of the second connection flow passage 19 is opened to the storage space 11a formed in the pipe part 11. For this reason, the first connection opening 17 has a function to supply fuel, which is supplied from the fuel pipe 2, to the pipe part 11. The connection of the fuel pipe 2 to the first connection opening 17 can be achieved by screwing, brazing, welding, or the like.

Further, the second connection flow passage 19 includes a reduced-diameter portion 19a. The reduced-diameter portion 19a is a flow passage of which the diameter is smaller than the diameter of the first connection flow passage 18. The reduced-diameter portion 19a may not be provided over the entire length of the second connection flow passage 19, and may be formed of; for example, a member, such as an orifice.

The first housing 12A is formed in a columnar shape. Further, the insertion opening 16 and the first connection opening 17 are formed on the same central axis A so that the connection direction of the fuel pipe 2 coincides with the insertion direction of the fuel injection device 3. Meanwhile, since the first housing 12A includes the first connection opening 17, the first housing 12A is longer than the other housings 12 in the direction of the central axis A.

As illustrated in FIGS. 1 and 2, the fixing bosses 13 are members that are used to fix the fuel distribution pipe 10 to the engine. The fixing of the fixing bosses 13 to the engine can be achieved by bolting, welding, or the like. Meanwhile, the positions of the fixing bosses 13 are set so that the fuel injection devices 3 inserted into the insertion openings 16 are inserted into the respective cylinders of the engine.

The fuel pressure sensor 14 detects the pressure of fuel that is stored in the pipe part 11. Various sensors, which detect the pressure of fuel by piezoelectric elements, variable resistors, or the like, can be used as the fuel pressure sensor 14.

Next, the flow of fuel caused by the fuel distribution pipe 10 will be described.

High-pressure fuel, which is compressed by the high-pressure pump 1, is supplied to the first connection opening 17 of the first housing 12A through the fuel pipe 2. The fuel, which is supplied to the first connection opening 17, is temporarily stored in the pipe part 11 through the second connection flow passage 19. The fuel, which is stored in the pipe part 11, is supplied to the insertion openings 16 of the respective housings 12 through the respective first connection flow passages 18, and is supplied to the fuel injection devices 3 that are inserted into the insertion openings 16. Further, the pressure of the fuel, which is stored in the pipe part 11, is detected by the fuel pressure sensor 14. Then, the control of the drive of the high-pressure pump 1, the determination of the failure of the fuel distribution pipe 10, and the like are performed on the basis of the detection result of the fuel pressure sensor 14.

As described above, in the fuel distribution pipe 10 according to this embodiment, the first housing 12A from among the plurality of housings 12, includes the first connection opening 17 that is connected to the fuel pipe 2 and communicates with the storage space 11a formed in the pipe part 11. That is, the first housing 12A supplies fuel to the fuel injection device 3 and supplies fuel, which is supplied from the fuel pipe 2, to the pipe part 11. For this reason, a component, which is separate from the housing 12 and supplies the fuel supplied from the fuel pipe 2 to the pipe part 11, is unnecessary. Accordingly, since the number of components is reduced, manufacturing cost can be reduced.

Further, the fuel supplied from the fuel pipe 2 is supplied to the respective fuel injection devices 3 through the first connection flow passages 18 after being supplied to the pipe part 11 through the second connection flow passage 19. For this reason, fuel of which the pressure is made uniform can be supplied to the respective fuel injection devices 3.

Furthermore, since the second connection flow passage 19 includes the reduced-diameter portion 19a of which the diameter is smaller than the diameter of the first connection flow passage 18, the pressure loss of fuel passing through the second connection flow passage 19 is larger than the pressure loss of fuel passing through the first connection flow passage 18. Accordingly, since fuel easily flows to the insertion openings 16 of the respective housings 12 from the pipe part 11, the pressure of fuel to be supplied to all the fuel injection devices 3 can be made more uniform.

### Second Embodiment

Next, a second embodiment will be described. The second embodiment is basically the same as the first embodiment, and is different from the first embodiment in terms of only the structure of the first housing. For this reason, in the following description, only a difference between the first and second embodiments will be described and the same description of the second embodiment as the description of the first embodiment will be omitted.

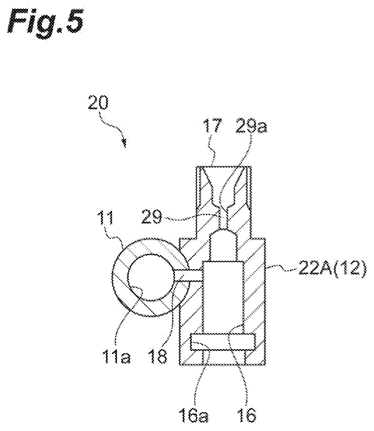

FIG. 5 is a schematic cross-sectional view of a fuel distribution pipe according to the second embodiment. FIG. 5 illustrates the same cross-section as FIG. 4. As illustrated in FIG. 5, a fuel distribution pipe 20 according to this embodiment includes a first housing 22A corresponding to the first housing 12A of the first embodiment.

The first housing 22A includes a third connection flow passage 29. On the other hand, the first housing 22A does not include a flow passage corresponding to the second connection flow passage 19 of the first embodiment.

The third connection flow passage 29 is a flow passage through which fuel passes, and is connected to the first connection opening 17 and the insertion opening 16. That is, one end of the third connection flow passage 29 is opened to the first connection opening 17, and the other end of the third connection flow passage 29 is opened to the insertion opening 16. For this reason, the first connection opening 17 communicates with the insertion opening 16 through the third connection flow passage 29. Further, the first connection opening 17 has a function to supply fuel, which is supplied from the fuel pipe 2, to the insertion opening 16.

Furthermore, the third connection flow passage 29 includes a reduced-diameter portion 29a. The reduced-diameter portion 29a is a flow passage of which the diameter is smaller than the diameter of the first connection flow passage 18. The reduced-diameter portion 29a may not be provided over the entire length of the third connection flow passage 29, and may be formed of, for example, a member, such as an orifice.

Next, the flow of fuel caused by the fuel distribution pipe 20 will be described.

High-pressure fuel, which is compressed by the high-pressure pump 1, is supplied to the first connection opening 17 of the first housing 12A through the fuel pipe 2. The fuel, which is supplied to the first connection opening 17, is supplied to the insertion opening 16 of the first housing 22A through the third connection flow passage 29, and is supplied to the fuel injection device 3 inserted into the insertion opening 16. Further, the fuel, which is supplied to the insertion opening 16, is temporarily stored in the pipe part 11 through the first connection flow passage 18. The fuel, which is stored in the pipe part 11, is supplied to the insertion openings 16 of the respective housings 12 other than the first housing 22A through the respective first connection flow passages 18, and is supplied to the fuel injection devices 3 that are inserted into the insertion openings 16. Furthermore, the pressure of the fuel, which is stored in the pipe part 11, is detected by the fuel pressure sensor 14.

Here, pressure, which is reduced due to the injection of fuel from the fuel injection device 3, is overwhelmingly smaller than the pressure of the fuel that is stored in the pipe part 11. Further, the amount of fuel to be injected from the fuel injection device 3 is overwhelmingly smaller than the amount of the fuel that is stored in the storage space 11a. Furthermore, since the amount of fuel to be injected from the fuel injection device 3 is very small and the flow velocity of fuel flowing through the fuel distribution pipe 20 is extremely low, the pressure loss of fuel passing through the first connection flow passage 18 is extremely small. For this reason, the fuel, which is supplied to the insertion opening 16 of the first housing 22A, is supplied to the pipe part 11 through the first connection flow passage 18. Moreover, a difference between the pressure of fuel, which is supplied to the fuel injection device 3 from the first housing 22A, and the pressure of fuel, which is supplied to the fuel injection devices 3 from the other housings 12, is extremely small.

As described above, in the fuel distribution pipe 20 according to this embodiment, the fuel supplied from the fuel pipe 2 is supplied to the fuel injection device 3 from the insertion opening 16 of the first housing 22A through the third connection flow passage 29. Further, the fuel supplied to the insertion opening 16 of the first housing 22A is supplied to the respective fuel injection devices 3 from the other housings 12 after being supplied to the pipe part 11 through the first connection flow passage 18. In regard to this flow of the fuel, fuel is not supplied to the insertion opening 16 of the first housing 22A from the pipe part 11 or it is difficult for fuel to be supplied to the insertion opening 16 of the first housing 22A from the pipe part 11. For this reason, it is difficult for the pulsation of fuel, which is generated due to the injection of fuel from the fuel injection device 3, to be transmitted to the pipe part 11 in the first housing 22A. Accordingly, since strength, which is required for the pipe part 11, can be made low, material cost can be reduced through a reduction in the thickness of the wall of the pipe part 11. Furthermore, since a flow passage to be connected to the first connection opening 17 and the pipe part 11 is not formed, the number of holes to be formed in the pipe part 11 can be made smaller than that in a case in which the flow passage is formed. Accordingly, since strength, which is required for the pipe part 11I, can be made low, material cost can be reduced through a reduction in the thickness of the wall of the pipe part 11.

Further, since the third connection flow passage 29 includes the reduced-diameter portion 29a of which the diameter is smaller than the diameter of the first connection flow passage 18, the pressure loss of fuel passing through the third connection flow passage 29 is larger than the pressure loss of fuel passing through the first connection flow passage 18. Accordingly, since fuel easily flows to the pipe part 11 from the insertion opening 16 of the first housing 22A, the pressure of fuel to be supplied to all the fuel injection devices 3 can be made more uniform.

### Third Embodiment

Next, a third embodiment will be described. The third embodiment is basically the same as the first embodiment. For this reason, in the following description, only a difference between the first and third embodiments will be described and the same description of the third embodiment as the description of the first embodiment will be omitted.

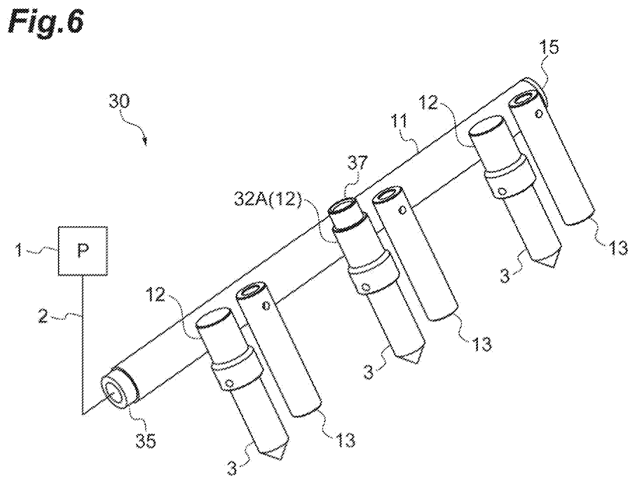

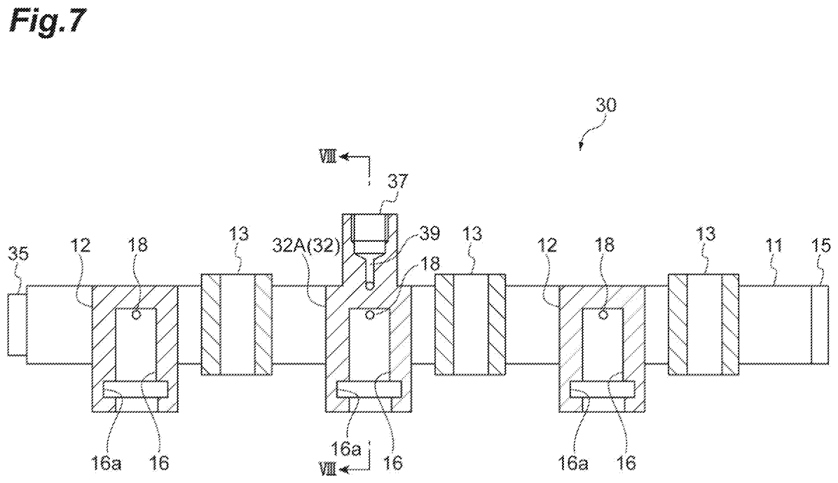

FIG. 6 is a schematic perspective view of a fuel distribution pipe according to the third embodiment. FIG. 7 is a schematic cross-sectional view of the fuel distribution pipe according to the third embodiment. As illustrated in FIGS. 6 and 7, a fuel distribution pipe 30 according to this embodiment includes a pipe part 11, a plurality of housings 12, and fixing bosses 13.

A lid part 15 is mounted on one end portion of the pipe part 11, and one end portion of a storage space 11a formed in the pipe part 11 is closed by the lid part 15. A pipe connection opening 35 is mounted on the other end portion of the pipe part 11 instead of the fuel pressure sensor of the first embodiment. The mounting of the lid part 15 and the pipe connection opening 35 on the pipe part 11 can be achieved by brazing, welding, screwing, or the like.

The pipe connection opening 35 is connected to the fuel pipe 2, so that fuel is supplied to the pipe connection opening 35 from the fuel pipe 2. Further, the pipe connection opening 35 is mounted on the pipe part 11, so that the pipe connection opening 35 communicates with the storage space 11a formed in the pipe part 11. For this reason, the pipe connection opening 35 has a function to supply fuel, which is supplied from the fuel pipe 2, to the pipe part 1.

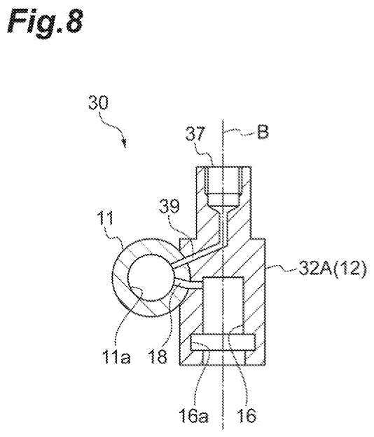

FIG. 8 is a schematic cross-sectional view taken along line VIII-VIII illustrated in FIG. 7. As illustrated in FIGS. 7 and 8, one of a plurality of housings 12 is a second housing 32A. The second housing 32A further includes a second connection opening 37 in addition to the structure of the other housing 12. Meanwhile, each of the other housings 12 other than the second housing 32A does not include the second connection opening 37.

The second connection opening 37 is connected to a fuel pressure sensor (not illustrated) that detects the pressure of fuel. The second connection opening 37 is a depression (recessed portion) that is formed in the second housing 32A and has a circular cross-section. The second connection opening 37 communicates with the storage space 11a, which is formed in the pipe part 11, through a fourth connection flow passage 39. The fourth connection flow passage 39 is a flow passage through which fuel passes, and is connected to the second connection opening 37 and the pipe part 11. That is, one end of the fourth connection flow passage 39 is opened to the second connection opening 37, and the other end of the fourth connection flow passage 39 is opened to the storage space 11a formed in the pipe part 11. For this reason, the second connection opening 37 has a function to supply fuel, which is stored in the pipe part 1l, to the fuel pressure sensor. The connection of the fuel pressure sensor to the second connection opening 37 can be achieved by screwing, brazing, welding, or the like.

The second housing 32A is formed in a columnar shape. Further, the insertion opening 16 and the second connection opening 37 of the second housing 32A are formed on the same central axis B so that the connection direction of the fuel pressure sensor coincides with the insertion direction of the fuel injection device 3. Meanwhile, since the second housing 32A includes the second connection opening 37, the second housing 32A is longer than the other housings in the direction of the central axis B.

Next, the flow of fuel caused by the fuel distribution pipe 30 will be described.

High-pressure fuel, which is compressed by the high-pressure pump 1, is supplied to the fuel distribution pipe 30 through the fuel pipe 2. The fuel, which is supplied to the fuel distribution pipe 30, is supplied to the pipe part 11 from the pipe connection opening 35, and is temporarily stored in the pipe part 11. The fuel, which is stored in the pipe part 11, is supplied to the insertion openings 16 of the respective housings 12 through the respective first connection flow passages 18, and is supplied to the fuel injection devices 3 that are inserted into the insertion openings 16. Further, the fuel, which is stored in the pipe part 11, is supplied to the fuel pressure sensor from the second connection opening 37 through the fourth connection flow passage 39. Then, the pressure of the fuel, which is stored in the pipe part 11, is detected by the fuel pressure sensor.

As described above, in the fuel distribution pipe 30 according to this embodiment, the second housing 32A from among the plurality of housings 12, includes the second connection opening 37 that is connected to the fuel pressure sensor and communicates with the pipe part 11. That is, the second housing 32A supplies fuel to the fuel injection device 3 and supplies fuel, which is stored in the pipe part 11, to the fuel pressure sensor. For this reason, a component, which is separate from the housing 12 and supplies the fuel stored in the pipe part 11 to the fuel pressure sensor, is unnecessary. Accordingly, since the number of components is reduced, manufacturing cost can be reduced.

### Fourth Embodiment

Next, a fourth embodiment will be described. The fourth embodiment is basically the same as the third embodiment, and is different from the third embodiment in terms of only the structure of the second housing. For this reason, in the following description, only a difference between the third and fourth embodiments will be described and the same description of the fourth embodiment as the description of the third embodiment will be omitted.

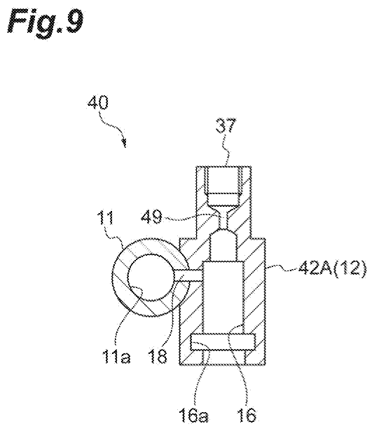

FIG. 9 is a schematic cross-sectional view of a fuel distribution pipe according to the fourth embodiment. FIG. 9 illustrates the same cross-section as FIG. 8. As illustrated in FIG. 9, a fuel distribution pipe 40 according to this embodiment includes a second housing 42A corresponding to the second housing 32A of the third embodiment.

The second housing 42A includes a fifth connection flow passage 49. On the other hand, the second housing 42A does not include a flow passage corresponding to the fourth connection flow passage 39 of the third embodiment.

The fifth connection flow passage 49 is a flow passage through which fuel passes, and is connected to the second connection opening 37 and the insertion opening 16. That is, one end of the fifth connection flow passage 49 is opened to the second connection opening 37, and the other end of the fifth connection flow passage 49 is opened to the insertion opening 16. For this reason, the second connection opening 37 communicates with the insertion opening 16 through the fifth connection flow passage 49. Further, the second connection opening 37 has a function to supply fuel, which is supplied to the insertion opening 16, to the fuel pressure sensor.

Next, the flow of fuel caused by the fuel distribution pipe 40 will be described.

High-pressure fuel, which is compressed by the high-pressure pump 1, is supplied to the fuel distribution pipe 40 through the fuel pipe 2. The fuel, which is supplied to the fuel distribution pipe 40, is supplied to the pipe part 11 from the pipe connection opening 35, and is temporarily stored in the pipe part 11. The fuel, which is stored in the pipe part 11, is supplied to the insertion openings 16 of the respective housings 12 through the respective first connection flow passages 18, and is supplied to the fuel injection devices 3 that are inserted into the insertion openings 16. Further, the fuel, which is supplied to the insertion opening 16 of the second housing 42A, is supplied to the fuel pressure sensor from the second connection opening 37 through the fifth connection flow passage 49. Furthermore, the fuel, which is supplied to the insertion opening 16, is detected as the pressure of the fuel, which is stored in the pipe part 11, by the fuel pressure sensor.

Since the pipe part 11 and the insertion opening 16 communicate with each other in the fuel distribution pipe 40 according to this embodiment as described above, the fuel supplied to the insertion opening 16 can be detected as the pressure of the fuel stored in the pipe part 11.

Further, since a flow passage connected to the second connection opening 37 and the pipe part 11 is not formed, the number of holes to be formed in the pipe part 11 can be made smaller than that in a case in which the flow passage is formed. Accordingly, since strength, which is required for the pipe part 11, can be made low, material cost can be reduced through a reduction in the thickness of the wall of the pipe part 11.

### Fifth Embodiment

Next, a fifth embodiment will be described. The fifth embodiment is a combination of the first and third embodiments. For this reason, in the following description, only a difference between the fifth embodiment and the first and third embodiments will be described and the same description of the fifth embodiment as the description of the first and third embodiments will be omitted.

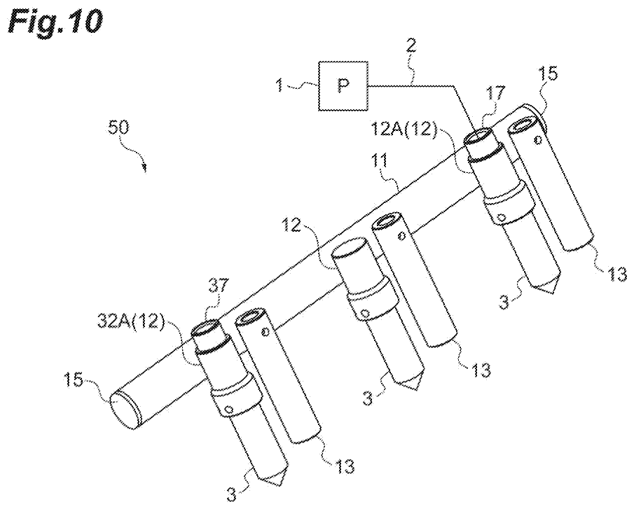

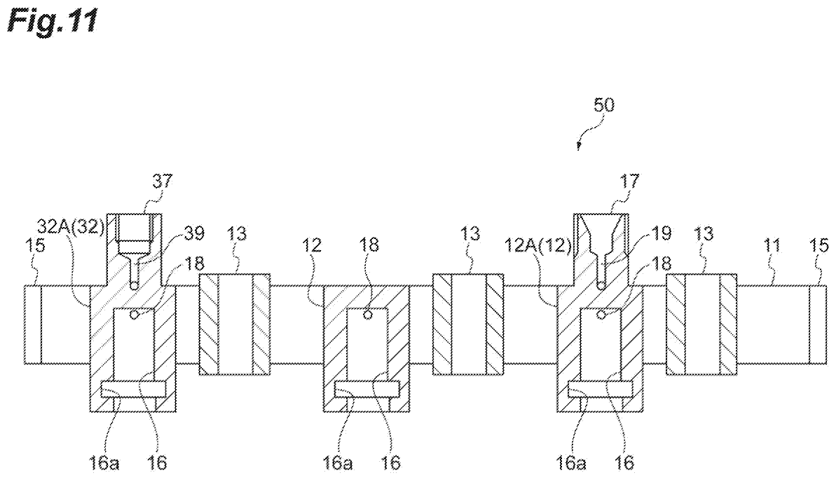

FIG. 10 is a schematic perspective view of a fuel distribution pipe according to the fifth embodiment. FIG. 11 is a schematic cross-sectional view of the fuel distribution pipe according to the fifth embodiment. As illustrated in FIGS. 10 and 11, a fuel distribution pipe 50 according to this embodiment includes a pipe part 11, a plurality of housings 12, and fixing bosses 13.

Lid parts 15 and 15 are mounted on both end portions of the pipe part 11, and both end portions of a storage space 11a formed in the pipe part 11 are closed by the lid parts 15 and 15. The mounting of the lid parts 15 and 15 on the pipe part 11 can be achieved by brazing, welding, screwing, or the like.

One of the plurality of housings 12 is a first housing 12A. Further, another of the plurality of housings 12 is a second housing 32A. The first housing 12A is the same as that of the first embodiment (see FIG. 4). The second housing 32A is the same as that of the third embodiment (see FIG. 8). Meanwhile, the first housing 22A of the second embodiment may be used instead of the first housing 12A (see FIG. 5). Further, the second housing 42A of the fourth embodiment may be used instead of the second housing 32A (see FIG. 9).

The arrangement of the first and second housings 12A and 32A is not particularly limited, but it is preferable that the first and second housings 12A and 32A are housings 12 not adjacent to each other. That is, it is preferable that housings 12, which are not the first and second housings 12A and 32A, are disposed between the first and second housings 12A and 32A. In this case, it is preferable that the first and second housings 12A and 32A are housings 12 positioned at both ends of the fuel distribution pipe among the plurality of housings 12. That is, it is preferable that the first housing 12A is the housing 12 positioned at one end of the fuel distribution pipe among the plurality of housings 12 and the second housing 32A is the housing 12 positioned at the other end of the fuel distribution, pipe opposite to the first housing 12A among the plurality of housings 12.

Next, the flow of fuel caused by the fuel distribution pipe 50 will be described.

High-pressure fuel, which is compressed by the high-pressure pump 1, is supplied to the first connection opening 17 of the first housing 12A through the fuel pipe 2. The fuel, which is supplied to the first connection opening 17, is temporarily stored in the pipe part 11 through the second connection flow passage 19. The fuel, which is stored in the pipe part 11, is supplied to the insertion openings 16 of the respective housings 12 through the first connection flow passages 18, and is supplied to the fuel injection devices 3 that are inserted into the insertion openings 16. Further, the fuel, which is stored in the pipe part 11, is supplied to the fuel pressure sensor from the second connection opening 37 through the fourth connection flow passage 39. Then, the pressure of the fuel, which is stored in the pipe part 11, is detected by the fuel pressure sensor.

Meanwhile, the flow of fuel becomes like those of the second and fourth embodiments in a case in which the first housing 22A of the second embodiment and the second housing 42A of the fourth embodiment are used instead of the first and second housings 12A and 32A.

As described above, in the fuel distribution pipe 50 according to this embodiment, the first housing 12A from among the plurality of housings 12, includes the first connection opening 17 that is connected to the fuel pipe 2 and communicates with the pipe part 11. That is, the first housing 12A supplies fuel to the fuel injection device 3 and supplies fuel, which is supplied from the fuel pipe 2, to the pipe part 11. For this reason, a component, which is separate from the housing 12 and supplies the fuel supplied from the fuel pipe 2 to the pipe part 11, is unnecessary. Further, the second housing 32A from among the plurality of housings 12, includes the second connection opening 37 that is connected to the fuel pressure sensor and communicates with the pipe part 11. That is, the second housing 32A supplies fuel to the fuel injection device 3 and supplies the fuel, which is stored in the pipe part 11, to the fuel pressure sensor. For this reason, a component, which is separate from the housing 12 and supplies the fuel stored in the pipe part 11 to the fuel pressure sensor, is unnecessary. Accordingly, since the number of components is reduced, manufacturing cost can be reduced.

Furthermore, the second housing 32A, which supplies fuel to the fuel pressure sensor, is provided at a position away from the first housing 12A that supplies the fuel supplied from the fuel pipe 2 to the pipe part 11. For this reason, the influence of the pulsation of fuel, which is caused by the operation of the high-pressure pump 1, on the fuel pressure sensor can be suppressed. Accordingly, a change in the pressure of fuel, which is detected by the fuel pressure sensor, caused by the pulsation of fuel can be suppressed.

### Sixth Embodiment

Next, a sixth embodiment will be described. The sixth embodiment is a combination of the second and fourth embodiments. For this reason, in the following description, only a difference between the sixth embodiment and the second and fourth embodiments will be described and the same description of the sixth embodiment as the description of the second and fourth embodiments will be omitted.

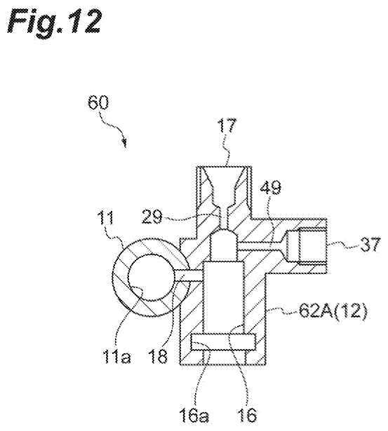

FIG. 12 is a schematic cross-sectional view of a fuel distribution pipe according to the sixth embodiment. FIG. 12 illustrates the same cross-section as FIGS. 5 and 9. As illustrated in FIG. 12, a fuel distribution pipe 60 according to this embodiment includes a pipe part 11, a plurality of housings 12, and fixing bosses 13 (see FIGS. 2 and 7).

One of the plurality of housings 12 is a third housing 62A. The third housing 62A is a combination of the first housing of the second embodiment and the second housing of the fourth embodiment. For this reason, the fuel distribution pipe 60 does not include the first housing of the second embodiment and the second housing of the fourth embodiment. The third housing 62A further includes a first connection opening 17 and a second connection opening 37 in addition to the structure of the other housing 12. The first connection opening 17 and the second connection opening 37 are the same as the first connection opening of the second embodiment and the second connection opening of the fourth embodiment. For this reason, the third housing 62A includes a third connection flow passage 29 that is connected to the first connection opening 17 and the insertion opening 16 and a fifth connection flow passage 49 that is connected to the second connection opening 37 and the insertion opening 16, as in the second and fourth embodiments. Meanwhile, each of the other housings 12 other than the first housing 12A does not include the first connection opening 17 and the second connection opening 37.

The third housing 62A is formed in a substantially T shape. That is, the first connection opening 17 and the insertion opening 16 are linearly disposed so as to be disposed on the same central axis A. On the other hand, the second connection opening 37 extends in a direction orthogonal to the first connection opening 17 and the insertion opening 16 so as to be connected to a portion between the first connection opening 17 and the insertion opening 16.

Next, the flow of fuel caused by the fuel distribution pipe 60 will be described.

High-pressure fuel, which is compressed by the high-pressure pump 1, is supplied to the first connection opening 17 of the third housing 62A through the fuel pipe 2. The fuel, which is supplied to the first connection opening 17, is supplied to the insertion opening 16 of the third housing 62A through the third connection flow passage 29, and is supplied to the fuel injection device 3 inserted into the insertion opening 16. Further, the fuel, which is supplied to the insertion opening 16, is temporarily stored in the pipe part 11 through the first connection flow passage 18. The fuel, which is stored in the pipe part 11, is supplied to the insertion openings 16 of the respective housings 12 other than the third housing 62A through the respective first connection flow passages 18, and is supplied to the fuel injection devices 3 that are inserted into the insertion openings 16. Furthermore, the fuel, which is supplied to the insertion opening 16 of the third housing 62A, is supplied to a fuel pressure sensor from the second connection opening 37 through the fifth connection flow passage 49. Then, the fuel, which is supplied to the insertion opening 16, is detected as the pressure of the fuel, which is stored in the pipe part 11, by the fuel pressure sensor.

As described above, in the fuel distribution pipe 60 according to this embodiment, the third housing 62A from among the plurality of housings 12, includes the first connection opening 17 that is connected to the fuel pipe 2 and communicates with the pipe part 11 and the second connection opening 37 that is connected to the fuel pressure sensor and communicates with the pipe part 11. That is, the third housing 62A supplies fuel to the fuel injection device 3, supplies the fuel, which is supplied from the fuel pipe 2, to the pipe part 11, and supplies the fuel, which is stored in the pipe part 11, to the fuel pressure sensor. For this reason, a component, which is separate from the housing 12 and supplies the fuel supplied from the fuel pipe 2 to the pipe part 11, and a component, which is separate from the housing 12 and supplies the fuel stored in the pipe part 11 to the fuel pressure sensor, are unnecessary. Accordingly, since the number of components is reduced, manufacturing cost can be reduced.

### Seventh Embodiment

Next, a seventh embodiment will be described. The seventh embodiment is a combination of the first and third embodiments. For this reason, in the following description, only a difference between the seventh embodiment and the first and third embodiments will be described and the same description of the seventh embodiment as the description of the first and third embodiments will be omitted.

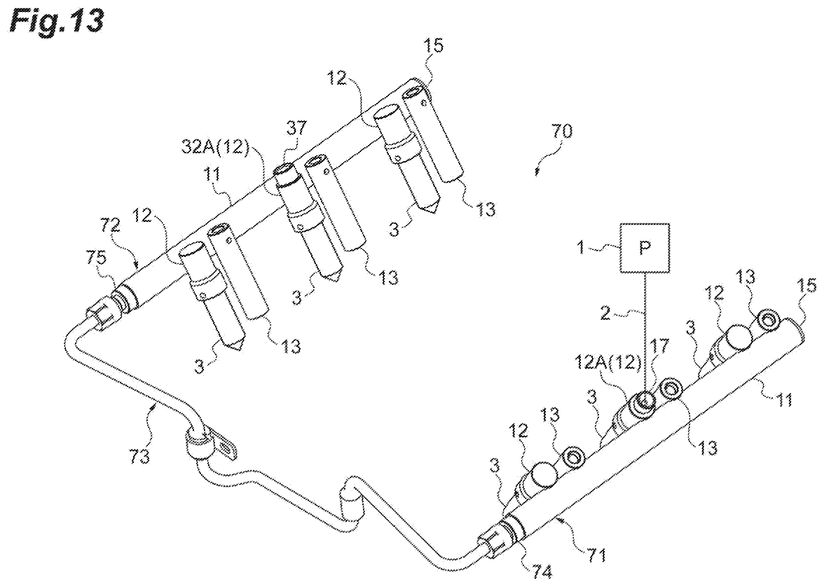

FIG. 13 is a schematic perspective view of a fuel distribution pipe according to the seventh embodiment. As illustrated in FIG. 13, the fuel distribution pipe 70 according to this embodiment is applied to a V-engine. The fuel distribution pipe 70 includes a first fuel distribution pipe unit 71, a second fuel distribution pipe unit 72, and a connection pipe unit 73.

The first fuel distribution pipe unit 71 is basically the same as the fuel distribution pipe 10 of the first embodiment, and includes a pipe part 11, a plurality of housings 12, and fixing bosses 13. On the other hand, the first fuel distribution pipe unit 71 does not include the fuel pressure sensor of the first embodiment.

The pipe part 1 is the same as that of the first embodiment. A lid part 15 is mounted on one end portion of the pipe part 11, and one end portion of a storage space 11a formed in the pipe part 11 is closed by the lid part 15. A first connection opening 74 to be connected to the connection pipe unit 73 is mounted on the other end portion of the pipe part 11 instead of the fuel pressure sensor of the first embodiment. The mounting of the lid part 15 and the first connection opening 74 on the pipe part 11 can be achieved by brazing, welding, screwing, or the like.

In the first fuel distribution pipe unit 71, one of the plurality of housings 12 is a first housing 12A. The first housing 12A is the same as that of the first embodiment. That is, the first housing 12A includes a first connection opening 17 to be connected to the fuel pipe 2, and the first connection opening 17 communicates with a storage space 11a, which is formed in the pipe part 11, through a second connection flow passage 19 (see FIG. 4).

The second fuel distribution pipe unit 72 is basically the same as the fuel distribution pipe 30 of the third embodiment, and includes a pipe part 11, a plurality of housings 12, and fixing bosses 13. On the other hand, the second fuel distribution pipe unit 72 does not include the pipe connection opening of the third embodiment.

The pipe part 11 is the same as that of the third embodiment. A lid part 15 is mounted on one end portion of the pipe part 11, and one end portion of the storage space 11a formed in the pipe part 11 is closed by the lid part 15. A second connection opening 75 to be connected to the connection pipe unit 73 is mounted on the other end portion of the pipe part 11 instead of the pipe connection opening of the third embodiment. The mounting of the lid part 15 and the second connection opening 75 on the pipe part 11 can be achieved by brazing, welding, screwing, or the like.

In the second fuel distribution pipe unit 72, one of the plurality of housings 12 is a second housing 32A. The second housing 32A is the same as that of the third embodiment. That is, the second housing 32A includes a second connection opening 37 to be connected to a fuel pressure sensor, and the second connection opening 37 communicates with a storage space 11a, which is formed in the pipe part 11, through a fourth connection flow passage 39 (see FIG. 8).

The connection pipe unit 73 is connected to the first fuel distribution pipe unit 71 and the second fuel distribution pipe unit 72. A flow passage through which fuel passes is formed in the connection pipe unit 73, and communicates with the pipe part 11 of the first fuel distribution pipe unit 71 and the pipe part 11 of the second fuel distribution pipe unit 72. One end portion of the connection pipe unit 73 is connected to the first connection opening 74 of the first fuel distribution pipe unit 71. The other end portion of the connection pipe unit 73 is connected to the second connection opening 75 of the second fuel distribution pipe unit 72. For this reason, the connection pipe unit 73 supplies fuel, which is supplied to the first fuel distribution pipe unit 71, to the second fuel distribution pipe unit 72.

Further, the first fuel distribution pipe unit 71 is disposed so as to correspond to the row of the cylinders arranged in series on one side of a V-engine by the fixing bosses 13 of the first fuel distribution pipe unit 71 and the connection pipe unit 73. The second fuel distribution pipe unit 72 is disposed so as to correspond to the row of the cylinders arranged in series on the other side of the V-engine by the fixing bosses 13 of the second fuel distribution pipe unit 72 and the connection pipe unit 73.

Next, the flow of fuel caused by the fuel distribution pipe 70 will be described.

First, high-pressure fuel, which is compressed by the high-pressure pump 1, is supplied to the first fuel distribution pipe unit 71 through the fuel pipe 2. In the first fuel distribution pipe unit 71, the fuel, which is supplied from the fuel pipe 2, is supplied to the first connection opening 17 of the first housing 12A. The fuel, which is supplied to the first connection opening 17, is temporarily stored in the pipe part 11 through the second connection flow passage 19. The fuel, which is stored in the pipe part 11, is supplied to the insertion openings 16 of the respective housings 12 through the respective first connection flow passages 18, and is supplied to the fuel injection devices 3 that are inserted into the insertion openings 16.

Then, the fuel, which is supplied to the first fuel distribution pipe unit 71, is supplied to the second fuel distribution pipe unit 72 from the pipe part 11 through the first connection opening 74 and the connection pipe unit 73. In the second fuel distribution pipe unit 72, the fuel, which is supplied from the distribution pipe unit 71, is supplied to the pipe part 11 from the first connection opening 74 and is temporarily stored in the pipe part 11. The fuel, which is stored in the pipe part 11, is supplied to the insertion openings 16 of the respective housings 12 through the respective first connection flow passages 18 and is supplied to the fuel injection devices 3 that are inserted into the insertion openings 16. Further, the fuel, which is stored in the pipe part 11, is supplied to the fuel pressure sensor from the second connection opening 37 through the fourth connection flow passage 39. Then, the pressure of the fuel, which is stored in the pipe part 11, is detected by the fuel pressure sensor.

Since the fuel distribution pipe 70 according to this embodiment includes the pair of first and second fuel distribution pipe units 71 and 72 as described above, the fuel distribution pipe 70 can be appropriately mounted on a V-engine. Further, since the pipe part 11 of the first fuel distribution pipe unit 71 and the pipe part 11 of the second fuel distribution pipe unit 72 communicate with each other through the connection pipe unit 73, fuel can be supplied to the second fuel distribution pipe unit 72 through the first fuel distribution pipe unit 71. Accordingly, a fuel supply route can be simplified. Furthermore, the first fuel distribution pipe unit 71 is provided with the first housing 12A that includes the first connection opening 17 to be connected to the fuel pipe 2, and the second fuel distribution pipe unit 72 is provided with the second housing 32A that includes the second connection opening 37 to be connected to the fuel pressure sensor. Accordingly, both the pressure of the fuel of the first fuel distribution pipe unit 71 and the pressure of the fuel of the second fuel distribution pipe unit 72 can be detected by one fuel pressure sensor.

Preferred embodiments of the invention have been described above, but the invention is not limited to the above-mentioned embodiments.

For example, the respective embodiments may be appropriately combined. For example, the first and second housings of the second and fourth embodiments may be used instead of the first and second housings of the seventh embodiment.

Further, the insertion opening into which the fuel injection device is inserted has been described as a supply port in the embodiments, but a connection opening to which a pipe to be connected to a fuel injection device is to be connected functions as a supply port in a case in which a fuel injection device is not inserted into a fuel distribution pipe as in a common rail.

### REFERENCE SIGNS LIST

1: high-pressure pump, 2: fuel pipe, 3: fuel injection device, 10: fuel distribution pipe, 11: pipe part, 11a: storage space, 12: housing, 12A: first housing, 13: fixing boss, 14: fuel pressure sensor, 15: lid part, 16: insertion opening, 16a: locking groove, 17: first connection opening, 18: first connection flow passage, 19: second connection flow passage, 19a: reduced-diameter portion, 20: fuel distribution pipe, 22A: first housing, 29: third connection flow passage, 29a reduced-diameter portion, 30: fuel distribution pipe, 32A: second housing, 35: pipe connection opening, 37: second connection opening, 39: fourth connection flow passage, 40: fuel distribution pipe, 42A: second housing, 49: fifth connection flow passage, 50: fuel distribution pipe, 60: fuel distribution pipe, 62A: third housing, 70: fuel distribution pipe, 71: first fuel distribution pipe unit, 72: second fuel distribution pipe unit, 73: connection pipe unit, 74: first connection opening, 75: second connection opening, A: central axis, B: central axis.

1. A fuel distribution pipe that distributes and supplies fuel supplied from a fuel pipe to a plurality of fuel injection devices, comprising:
a pipe part that stores the fuel in a high-pressure state; and
a plurality of housings that are joined to the pipe part and supply the fuel to the fuel injection devices,
wherein a first housing from among the plurality of housings includes a first connection opening that is connected to the fuel pipe and communicates with the pipe part.

2. A fuel distribution pipe that distributes and supplies fuel supplied from a fuel pipe to a plurality of fuel injection devices, comprising:
a pipe part that stores the fuel in a high-pressure state; and
a plurality of housings that are joined to the pipe part and supply the fuel to the fuel injection devices,
wherein a second housing from among the plurality of housings includes a second connection opening that is connected to a fuel pressure sensor detecting the pressure of the fuel and communicates with the pipe part.

3. A fuel distribution pipe that distributes and supplies fuel supplied from a fuel pipe to a plurality of fuel injection devices, comprising:
a pipe part that stores the fuel in a high-pressure state; and
a plurality of housings that are joined to the pipe part and supply the fuel to the fuel injection devices,
wherein a first housing from among the plurality of housings includes a first connection opening that is connected to the fuel pipe and communicates with the pipe part, and
a second housing from among the plurality of housings includes a second connection opening that is connected to a fuel pressure sensor detecting the pressure of the fuel and communicates with the pipe part.

4. The fuel distribution pipe according to claim 3,
wherein the first and second housings are housings that are not adjacent to each other.

5. A fuel distribution pipe that distributes and supplies fuel supplied from a fuel pipe to a plurality of fuel injection devices, comprising:
a pipe part that stores the fuel in a high-pressure state; and
a plurality of housings that are joined to the pipe part and supply the fuel to the fuel injection devices,
wherein a third housing from among the plurality of housings includes a first connection opening that is connected to the fuel pipe and communicates with the pipe part, and a second connection opening that is connected to a fuel pressure sensor detecting the pressure of the fuel and communicates with the pipe part.

6. A fuel distribution pipe that distributes and supplies fuel supplied from a fuel pipe to a plurality of fuel injection devices, comprising:
a first fuel distribution pipe unit that includes a pipe part storing the fuel in a high-pressure state and a plurality of housings joined to the pipe part and supplying the fuel to the fuel injection devices, a first housing from among the plurality of housings including a first connection opening that is connected to the fuel pipe and communicates with the pipe part;
a second fuel distribution pipe unit that includes a pipe part storing the fuel in a high-pressure state and a plurality of housings joined to the pipe part and supplying the fuel to the fuel injection devices, a second housing from among the plurality of housings including a second connection opening that is connected to a fuel pressure sensor detecting the pressure of the fuel and communicates with the pipe part; and
a connection pipe unit that connects the first fuel distribution pipe unit to the second fuel distribution pipe unit and communicates with the pipe part of the first fuel distribution pipe unit and the pipe part of the second fuel distribution pipe unit.

7. The fuel distribution pipe according to claim 1,
wherein each of the housings includes a supply port that supplies the fuel to one of the fuel injection devices, and
the fuel distribution pipe further includes first connection flow passages that are each connected to the pipe part and the supply port, and a second connection flow passage that is connected to the first connection opening and the pipe part.

8. The fuel distribution pipe according to claim 7,
wherein the second connection flow passage includes a reduced-diameter portion of which the diameter is smaller than the diameter of the first connection flow passage.

9. The fuel distribution pipe according to claim 1,
wherein each of the housings includes a supply port that supplies the fuel to one of the fuel injection devices, and
the fuel distribution pipe further includes first connection flow passages that are each connected to the pipe part and the supply port, and a third connection flow passage that is connected to the first connection opening and the supply ports.

10. The fuel distribution pipe according to claim 9,
wherein the third connection flow passage includes a reduced-diameter portion of which the diameter is smaller than the diameter of the first connection flow passage.

11. The fuel distribution pipe according to claim 3,
wherein each of the housings includes a supply port that supplies the fuel to one of the fuel injection devices, and
the fuel distribution pipe further includes first connection flow passages that are each connected to the pipe part and the supply port, and a second connection flow passage that is connected to the first connection opening and the pipe part.

12. The fuel distribution pipe according to claim 11,
wherein the second connection flow passage includes a reduced-diameter portion of which the diameter is smaller than the diameter of the first connection flow passage.

13. The fuel distribution pipe according to claim 5,
wherein each of the housings includes a supply port that supplies the fuel to one of the fuel injection devices, and
the fuel distribution pipe further includes first connection flow passages that are each connected to the pipe part and the supply port, and a second connection flow passage that is connected to the first connection opening and the pipe part.

14. The fuel distribution pipe according to claim 13,
wherein the second connection flow passage includes a reduced-diameter portion of which the diameter is smaller than the diameter of the first connection flow passage.

15. The fuel distribution pipe according to claim 6,
wherein each of the housings includes a supply port that supplies the fuel to one of the fuel injection devices, and
the fuel distribution pipe further includes first connection flow passages that are each connected to the pipe part and the supply port, and a second connection flow passage that is connected to the first connection opening and the pipe part.

16. The fuel distribution pipe according to claim 3,
wherein each of the housings includes a supply port that supplies the fuel to one of the fuel injection devices, and
the fuel distribution pipe further includes first connection flow passages that are each connected to the pipe part and the supply port, and a third connection flow passage that is connected to the first connection opening and the supply ports.

17. The fuel distribution pipe according to claim 16,
wherein the third connection flow passage includes a reduced-diameter portion of which the diameter is smaller than the diameter of the first connection flow passage.

18. The fuel distribution pipe according to claim 5,
wherein each of the housings includes a supply port that supplies the fuel to one of the fuel injection devices, and
the fuel distribution pipe further includes first connection flow passages that are each connected to the pipe part and the supply port, and a third connection flow passage that is connected to the first connection opening and the supply ports.

19. The fuel distribution pipe according to claim 18,
wherein the third connection flow passage includes a reduced-diameter portion of which the diameter is smaller than the diameter of the first connection flow passage.

20. The fuel distribution pipe according to claim 6,
wherein each of the housings includes a supply port that supplies the fuel to one of the fuel injection devices, and
the fuel distribution pipe further includes first connection flow passages that are each connected to the pipe part and the supply port, and a third connection flow passage that is connected to the first connection opening and the supply ports.
